(19) United States
(12) Patent Application Publication
(10) Pub. No.: US 2025/0164303 A1
(43) Pub. Date: May 22, 2025

(54) Adjustable Measuring Cup

(71) Applicant: Progressive International Corp., Kent, WA (US)

(72) Inventors: Lawrence M. Hauser, Auburn, WA (US); Geoff Woo, Seattle, WA (US)

(73) Assignee: Progressive International Corp., Kent, WA (US)

(21) Appl. No.: 18/517,286

(22) Filed: Nov. 22, 2023

(51) Int. Cl. G01F 19/00; B65D 21/08

(52) U.S. Cl. CPC G01F 19/002; B65D 21/086

(57) ABSTRACT

An adjustable measuring cup includes a piston having an upper end terminating in a platform and is surrounded by a sleeve for movement of the piston with respect to the sleeve along a central axis to create a plurality of selectable interior volumes. The piston has an engagement surface and a disengagement surface, the engagement surface extending radially outwardly from the piston relatively farther than the disengagement surface. A bumper is mounted on the sleeve. The sleeve is rotatable with respect to the piston between an engagement position in which the bumper is frictionally engaged with the engagement surface, and a disengagement position in which the bumper is positioned over the disengagement surface.

### BACKGROUND OF THE INVENTION

In the course of cooking and baking, it is often essential to have many measuring cups for numerous ingredients to be measured in varying amounts. This can create disarray and clutter as multiple cups are used, and thereafter requires more effort to clean the many measuring cups.

To address these or additional concerns, others have created measuring cups that are adjustable, allowing cooks to measure and dispense a first ingredient at a first desired volume, and thereafter use the same adjustable measuring cup to measure and dispense any number of additional ingredients at any number of different desired volumes. In general, such pre-existing adjustable measuring cups include a fixed piston surrounded by a movable cylindrical sleeve which can move up and down with respect to the piston. As the sleeve moves upward or downward, an available volume defined within the cylindrical sleeve changes.

Although the principle behind these pre-existing adjustable measuring cups is suitable, they suffer a number of defects. For example, existing adjustable measuring cups tend to have a poor seal at the interface between the piston and the cylindrical sleeve, making the measuring cup undesirable for measuring liquids. Existing adjustable measuring cups also tend to employ an interaction between the piston and the sleeve which is ineffective at maintaining the piston at a desired height to produce a desired measuring volume. The simplest devices rely solely on friction between the piston and the sleeve, thereby incurring a tradeoff between the ability to maintain a desired position and the ability to easily move the sleeve from one position to another.

### SUMMARY OF THE INVENTION

A preferred adjustable measuring cup includes a piston having an upper end terminating in a platform and an opposing lower base. A sleeve having an upper rim, a lower end, an interior sidewall and an exterior sidewall receives the piston within it for movement of the piston with respect to the sleeve along a central axis to create a plurality of selectable interior volumes, each of the selectable interior volumes being bounded by the platform, the upper rim, and a selected portion of the interior sidewall between the platform and the upper rim.

The piston further has an engagement surface and a disengagement surface, the engagement surface extending radially outwardly from the piston relatively farther than the disengagement surface. A bumper is mounted on the sleeve, the bumper having an interior surface extending radially inwardly from the interior sidewall. The sleeve is rotatable with respect to the piston about the central axis for rotational movement of the sleeve between an engagement position and a disengagement position, wherein in the engagement position the interior surface of the bumper is frictionally engaged with the engagement surface, and in the disengagement position the interior surface of the bumper is disengaged from the engagement surface and positioned over the disengagement surface.

In some versions, the engagement surface extends parallel to the central axis.

In some versions, the disengagement surface extends parallel to the central axis.

In some versions, the bumper further extends radially outward from the exterior sidewall of the sleeve.

In some versions, a plurality of bumpers and a plurality of engagement surfaces are provided, wherein in the engagement position the interior surface of each of the plurality of bumpers is frictionally engaged with one of the plurality of engagement surfaces, and wherein in the disengagement position the interior surface of each of the plurality of bumpers is disengaged from the plurality of engagement surfaces and is positioned over the disengagement surface.

In some versions, the plurality of bumpers includes three or more bumpers, and wherein the plurality of engagement surfaces comprises three or more engagement surfaces.

In some versions, the disengagement surface includes a plurality of disengagement surfaces, and further wherein each of the plurality of engagement surfaces is separated from another of the plurality of engagement surfaces by one of the plurality of disengagement surfaces.

In some versions, the interior surface of each of the bumpers is formed from an elastomeric material.

In some versions, the interior surface of each of the bumpers has a bumper width and each of the engagement surfaces has an engagement surface width orthogonal to the central axis, the engagement surface width being in the range of 0.5 to 2.0 times the bumper width along a path extending at least 50 percent of the distance between the lower base and the upper end of the piston.

In some versions, a set of volumetric markings is positioned on one or the other of the sleeve or the piston.

In some versions, an elastomeric flange extends radially outward from the piston along the perimeter of the platform.

In yet other versions, the adjustable measuring cup includes a piston having a lower base and an opposing upper end terminating in a planar platform, and a hollow cylindrical sleeve having a sidewall extending between a lower end and an upper rim, the sidewall having an interior sidewall side and an exterior sidewall side.

The piston is received within the sleeve for movement of the piston with respect to the sleeve along a central axis to create a plurality of selectable interior volumes, each of the selectable interior volumes being bounded by the platform, the upper rim, and a selected portion of the sidewall between the platform and the upper rim. The piston further has a plurality of engagement surfaces and a plurality of disengagement surfaces, each of the engagement surfaces extending along an outer portion of the piston along a path parallel to the central axis, each of the disengagement surfaces extending along the outer portion of the piston, the engagement surfaces each extending radially outwardly from the piston relatively farther than the disengagement surfaces, each of the plurality of engagement surfaces being separated from others of the plurality of engagement surfaces by one of the plurality of disengagement surfaces.

A plurality of bumpers is mounted on the sleeve, each of the plurality of bumpers having an interior surface extending radially inwardly from the interior sidewall side. The sleeve is rotatable with respect to the piston about the central axis for rotational movement of the sleeve between an engagement position and a disengagement position, wherein in the engagement position the interior surface of each of the plurality of bumpers is frictionally engaged with one of the plurality of engagement surfaces, and in the disengagement position the interior surface of each of the plurality of bumpers is disengaged from the engagement surfaces and is positioned over one of the plurality of disengagement surfaces.

In some versions, the engagement surfaces are each distributed equidistantly about the perimeter of the piston.

In some versions, the bumpers are each distributed equidistantly about the perimeter of the sleeve.

In some versions, each of the engagement surfaces extend about the perimeter of the piston for a distance greater than that of each of the disengagement surfaces.

In some versions, the plurality of bumpers comprises three or more bumpers, and wherein the plurality of engagement surfaces comprises three or more engagement surfaces.

In some versions, interior surface of each of the bumpers is formed from an elastomeric material.

In some versions, the elastomeric material comprises silicone.

The adjustable measuring cup of claim 14, further comprising a set of volumetric markings positioned on one or the other of the sleeve or the piston.

In some versions, an elastomeric flange extends radially outward from the piston along the perimeter of the platform.

### BRIEF DESCRIPTION OF THE DRAWINGS

The preferred embodiments of the invention are described below with reference to the following drawings.

FIG. 1 is a front isometric view of a preferred adjustable measuring cup.

FIG. 2 is a front elevational view of a preferred adjustable measuring cup.

FIG. 3 is a perspective view of a preferred outer sleeve for use with a preferred adjustable measuring cup.

FIG. 4 is front elevational view of a preferred piston for use with a preferred adjustable measuring cup.

FIG. 5 is a top plan view of the piston, taken along plane 5-5 in FIG. 4.

FIG. 6 is a top plan view of a preferred outer sleeve for use with a preferred adjustable measuring cup.

FIG. 7 is a front elevational view of a preferred adjustable measuring cup, illustrated in a position in which the outer sleeve is rotated to a first rotational position to allow vertical movement of the outer sleeve with respect to the piston.

FIG. 8 is a front elevational view of a preferred adjustable measuring cup, illustrated in a position in which the outer sleeve is rotated to a second rotational position to impede vertical movement of the outer sleeve with respect to the piston.

### DETAILED DESCRIPTION OF THE PREFERRED EMBODIMENT

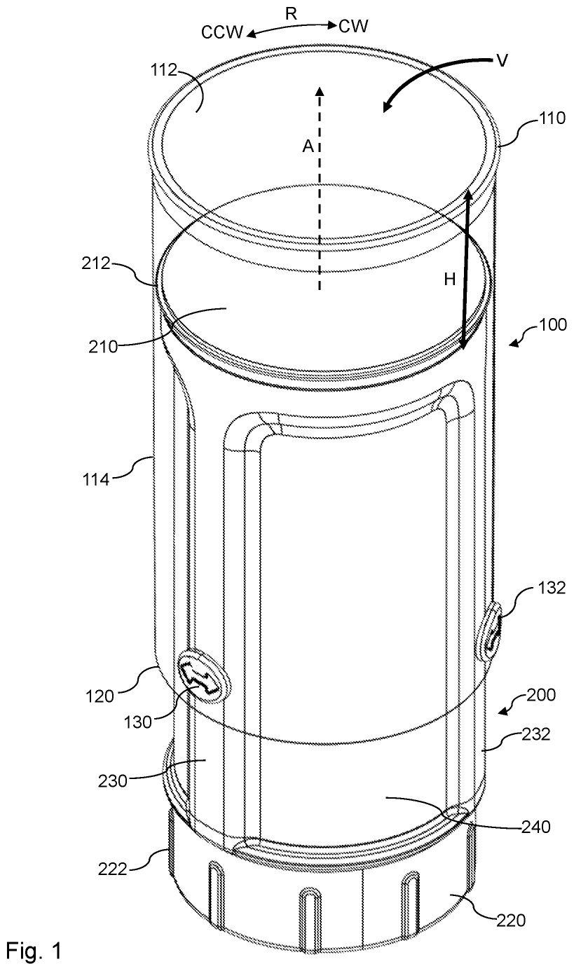

A preferred version of an adjustable measuring cup is shown in the accompanying figures. With reference to FIG. 1, the preferred adjustable measuring cup includes an outer sleeve 100 surrounding and inner piston 200. Each of the outer sleeve and the inner piston is defined by a central axis A which extends through the center of each of the outer sleeve and the inner piston.

In the illustrated example, the outer sleeve is cylindrical, having an open upper rim 110 and an open lower rim 120. As seen in FIG. 1, the central axis A extends through the center of the outer sleeve. The outer sleeve further includes a lower end 120 and an upper rim 110. The outer sleeve also includes an exterior sidewall 114 and an interior sidewall 112, each of which extends from the lower end to the upper rim. One or more bumpers 130, 132 are positioned on the outer sleeve, as described further below. In the preferred version, the outer sleeve is entirely transparent, or translucent. In other versions, the outer sleeve need not be translucent.

Preferably, the piston is also substantially cylindrical, which in the illustrated version is configured with one or more vertical ribs or engagement surfaces as described further below. The central axis A also extends through the center of the piston. In the illustrated example, the piston includes a base 220 at a lower end, and which may optionally have a plurality of ridges 222 or other textured features to enable a better grip for use in rotating the piston with respect to the sleeve. The opposing upper end of the piston terminates in an upper platform 210, which preferably is planar and perpendicular to the central axis. As also discussed further below, the outer sidewall of the piston preferably includes features to allow the outer sleeve to engage or disengage the nature of its frictional interaction with the piston. In the illustrated example, the piston includes one or more outward engagement surfaces 230, 232 which extend radially outwardly beyond one or more relatively more inward disengagement surfaces 240.

The outer sleeve is sized and arranged to receive the piston within the space defined by the interior sidewall 112 of the outer sleeve, and also to allow the outer sleeve to rotate with respect to the piston, and thus about the central axis. As indicated in FIG. 1, the outer sleeve preferably is arranged for rotation with respect to the piston either in a clockwise direction (that is, in the direction labeled by the arrow R, pointing in the direction of the indicator CW) or in a counterclockwise direction (in the direction labeled by the arrow R, pointing in the direction of the indicator CCW).

In the position of the adjustable measuring cup as shown in FIG. 1, the sleeve has been moved upward with respect to the piston by a distance H, to thereby define an interior volume V within a space defined by the interior sidewall 112 of the outer sleeve and the upper platform 210 of the piston 200. When the platform is positioned at a given distance H below the rim 110, a given diameter of the sleeve produces a known volume for the interior space when the outer sleeve is positioned at the height H. Accordingly, a user may position the sleeve at a desired location with respect to the piston to produce a desired interior volume V for the adjustable measuring cup.

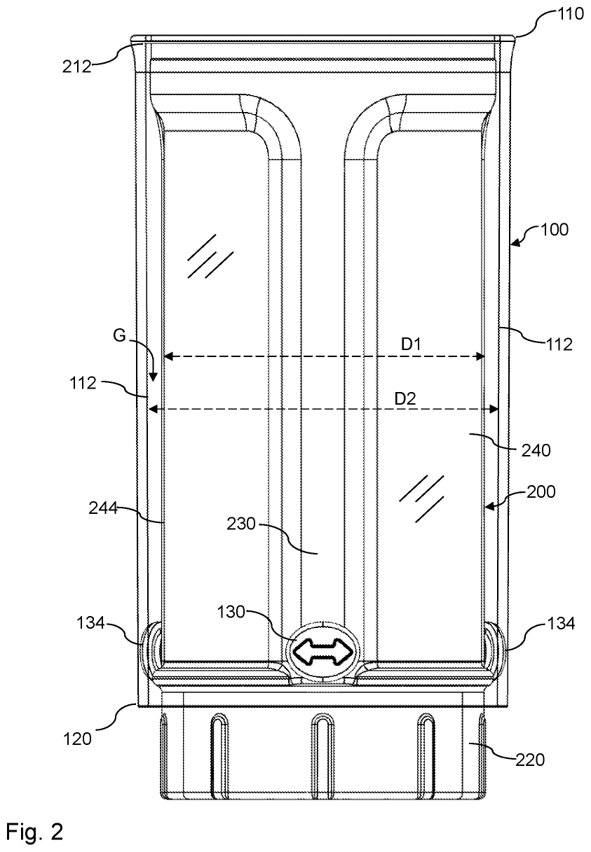

FIG. 2 shows a preferred adjustable measuring cup, in which the sleeve 100 has been moved downward with respect to the position shown in FIG. 1, essentially placing the adjustable measuring cup in a compact position for storage. As shown in this example, preferably the piston has a piston height along the central axis from the piston base 220 to the piston platform 210 which is greater than a sleeve height along the central axis from the lower rim 120 to the upper rim 110, so that all or a portion of the base 220 extends below the lower rim 120 of the sleeve when the upper rim 110 of the sleeve is at the same height as the platform 210.

FIG. 2 also illustrates an interior diameter D2 of the sleeve, extending through and perpendicular to the central axis and spanning the distance across the interior sidewalls 112 of the sleeve. An interior diameter D1 if the piston is also shown, taken across the locations of the opposing disengagement surfaces 240, 244. At those locations, the interior diameter D1 is less than the diameter D2, and further there is a distinct gap G between the piston and the sleeve at this position, so that the piston and sleeve are not in contact with one another. There is, however contact between the bumper 130 and engagement surface 230, as described further below.

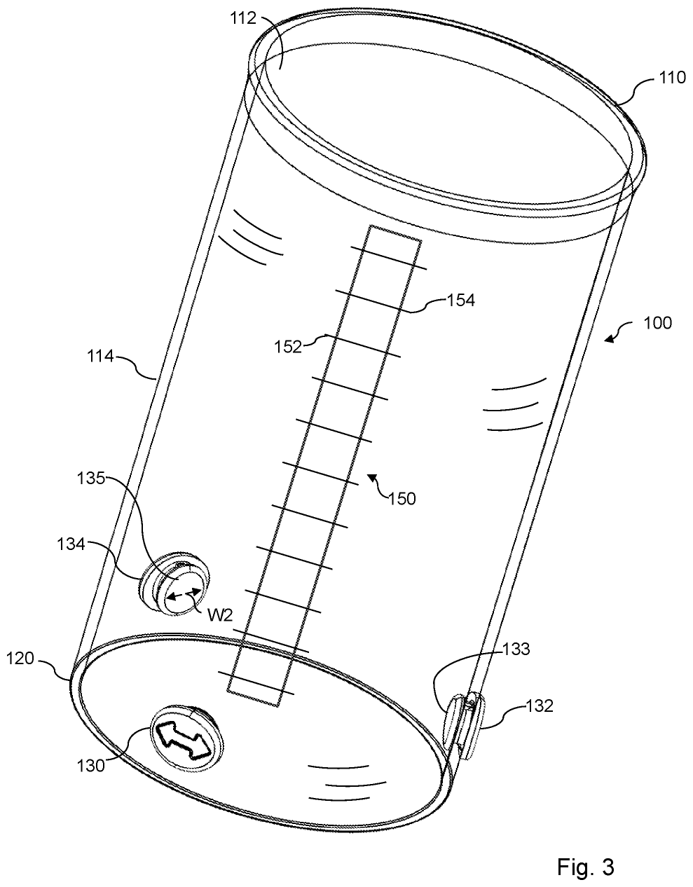

FIG. 3 shows an isometric view of a preferred sleeve. In this example, a set of volumetric indicators 150 is provided on the sleeve, indicating the corresponding volume of the interior volume V (see FIG. 1) when the platform of the piston is located at a particular level on the volumetric indicator. The volumetric indicator may include multiple measurement types, such as a set indicated in cups or fractions of cups on one side 152 and a set measured in ounces or portions of a liter on another side 154.

The bumpers are also more readily visible in FIG. 3. In this example, the sleeve includes three bumpers 130, 132, 134, each distributed equidistantly about the perimeter of the sleeve. A portion of each bumper extends radially outward of the outer surface of the sleeve, thereby providing a grip or handle for grasping by a user. As shown, a directional indicator is provided in the form of double-headed arrows, indicating to the user that the bumper, and therefore the sleeve, can be moved in the direction of either arrow head. A portion of each bumper extends through the sleeve and terminates in an interior end 133, 135. In the illustrated example, at least the interior end of each bumper is formed from an elastomeric material such as silicone, and is sized and arranged to provide a high degree of frictional engagement with the engagement surfaces of the piston. As also seen in FIG. 3, preferably the interior end of each bumper has a generally circular shape (though other shapes are possible), and a diameter or width W2 (in which the width is taken along a plane which is orthogonal to the central axis).

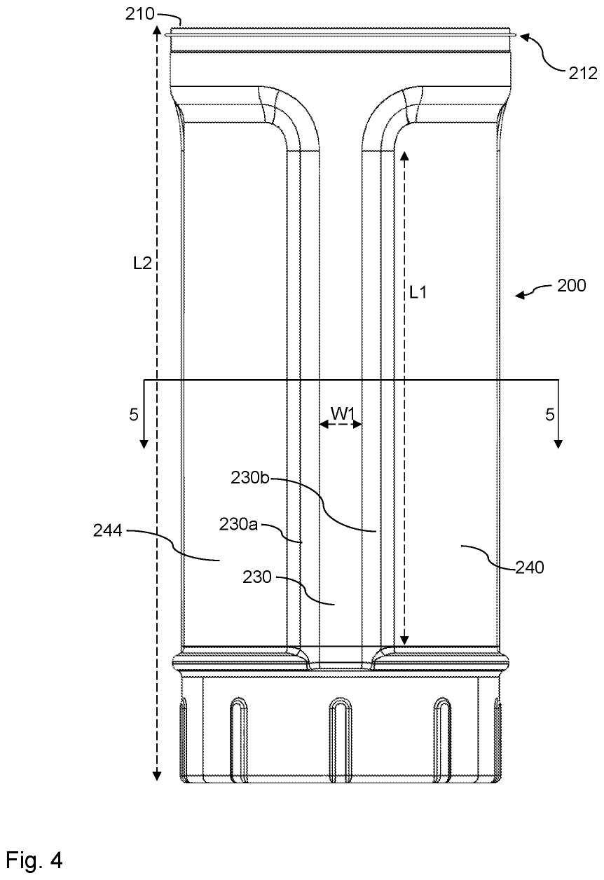

The preferred piston is shown in an elevational view in FIG. 4, including indicated section plane 5-5 extending generally across the middle of the piston. Near the upper platform 210, and preferably as close to the height of the upper platform as is practicable, a peripheral flange 212 is provided on the piston. The flange 212 is preferably formed from an elastomeric material such as silicone, and is sized and arranged to form a snug frictional fit against the interior sidewall of the sleeve. Accordingly, the flange allows liquids to be received in the interior volume without leaking through the interface between the sleeve and the piston (at the flange), and further acts as a squeegee in the event the user fills the interior volume and the pushes the piston upward with respect to the sleeve to expel the contents of the interior volume.

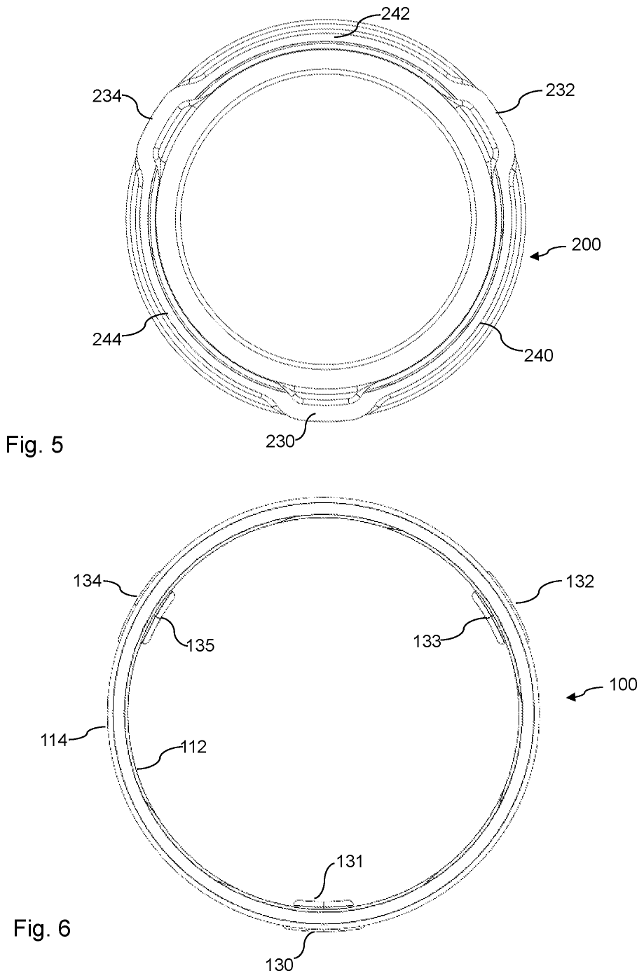

The sectional view of FIG. 5 most clearly shows the engagement services and disengagement services of the piston. In the illustrated example, there are three engagement surfaces 230, 232, 234. Likewise, there are three disengagement surfaces, 240, 242, 244. As shown, each of the engagement services extends radially farther outwardly from the center of the piston (that is, the location of the central axis) than does each of the disengagement surfaces. As best seen for example in FIGS. 1 and 2, each of the disengagement surfaces and engagement surfaces preferably extend vertically along substantially the majority or the entirety of the piston between the base and the upper platform.

Returning to FIG. 4, one of the engagement surfaces 230 is visible. In various embodiments, the piston may have only one engagement surface, or may have a plurality of engagement surfaces. Most preferably, three such engagement surfaces are provided, spaced equidistantly about the circumference of the pillar, to allow for uniform contact between the bumpers and the engagement surfaces. In other versions, four engagement surfaces may be provided.

As shown in FIG. 4, the engagement surface has a width W1 measured across the most radially distant portion of the engagement surface, and comprising the portion of the engagement surface which will contact the interior surface of the bumper for the greatest contact and highest degree of friction. On either side of the engagement surface, there may be a sloped or tapered transition surface 230a, 230b between the disengagement surfaces 240, 244 and the engagement surface 230. In preferred versions, the engagement surface maintains a width within this preferred range for the entire height L1, where the height L1 is preferably at least 40 percent, or at least 50 percent, and more preferably at least 60 percent, of the height L1 of the piston.

As seen in FIG. 3 the interior surface of the bumper 135 has a width W2. In one version, the widths of the bumper W2 and that of the engagement surface W1 are approximately equal to one another. More preferably, the width W1 is in the range of 0.5 to 2.0 times that of the width W2. In addition this preferred width range of the engagement surface extends along the entire height of the engagement surface, shown as L1 in FIG. 4. In some versions, the width W1 need not be exactly the same along the height L1, but preferably still falls within the preferred range (even if it may vary along that height) for the entirety of the height.

FIG. 6 shows a top plan view of the preferred sleeve. In this view, each of the bumpers 130, 132, 134 can be seen extending radially outwardly beyond the outer sidewall 114 of the sleeve. Likewise, the interior ends 131, 133, 135 of each of the bumpers is visible extending radially inwardly from the interior surface 112 of the sleeve. As can be seen by viewing FIGS. 5 and 6 in tandem, a bumper is preferably located at a circumferential location on the sleeve corresponding to the same circumferential location of an engagement surface on the piston. Thus, just as there are three distinct engagement surfaces distributed equidistantly about the circumference of the piston, there are three bumpers having interior ends spaced equidistantly about the circumference of the sleeve.

In other examples, each of the piston and the sleeve may have a larger or smaller number of engagement surfaces and bumpers. Likewise, in some embodiments, there may be more or fewer bumpers than the number of engagement surfaces. As further shown in FIG. 5, in the preferred example each engagement surface spans a smaller distance about the perimeter of the piston than does the disengagement surface. Thus, in one example as illustrated, each engagement surface occupies about one-twelfth of the total circumference while each disengagement surface occupies about one quarter of the total circumference of the piston. This arrangement allows for a greater amount of disengagement between the sleeve and the piston, thereby making it easier to move the piston with respect to the sleeve by providing a larger disengagement position.

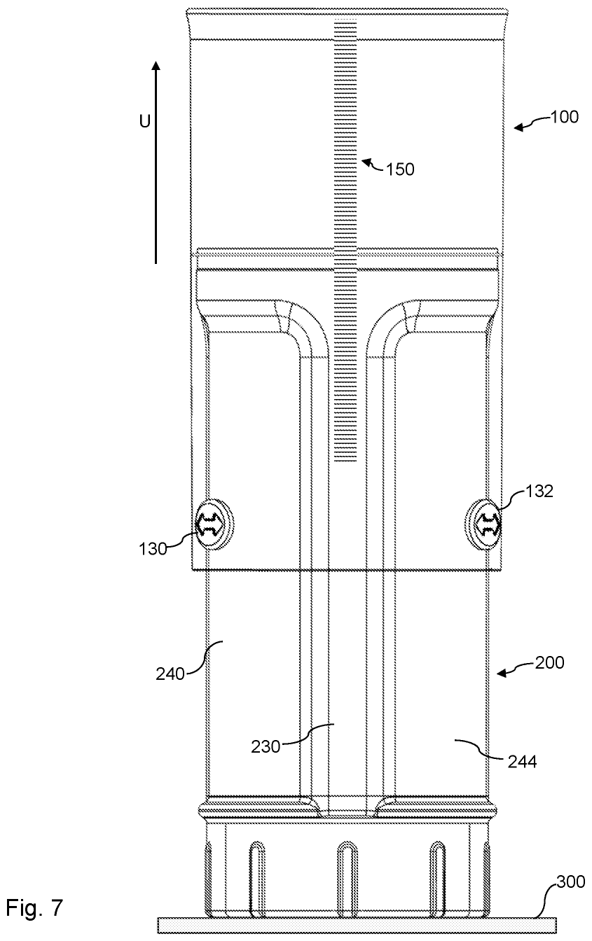

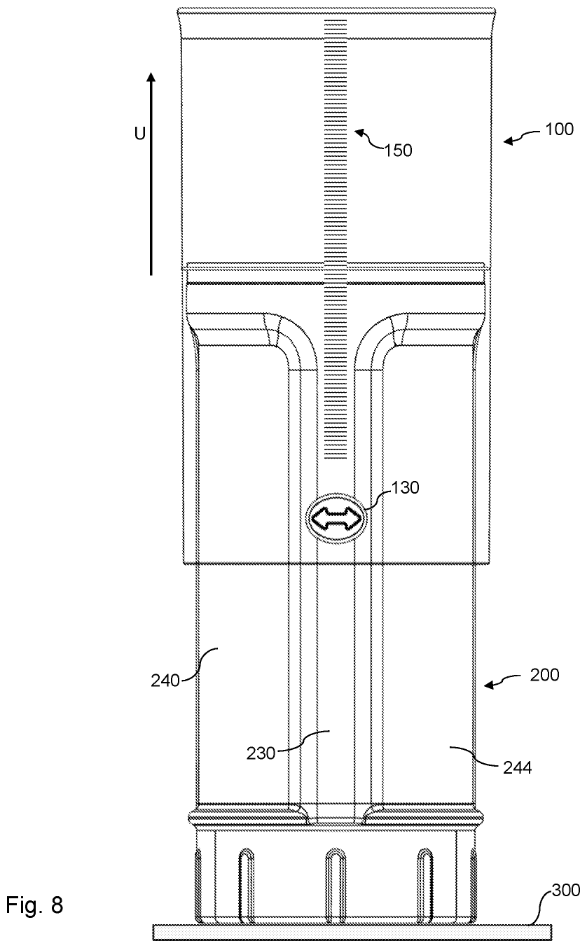

FIGS. 7 and 8 show the disengagement and engagement positions of the sleeve with respect to the piston. FIG. 7 shows the disengagement position, in which the sleeve has been rotated with respect to the piston such that the bumpers are each positioned over the disengagement surface locations of the piston. The bumpers and the disengagement surfaces are sized and arranged such that the interior ends 131, 133, 135 of the bumpers do not touch the disengagement surfaces of the piston when the bumpers are positioned over the disengagement surfaces as shown. Alternatively, if they contact one another then the amount of contact is small and provides little or no discernible frictional resistance. In this disengagement position, the sleeve 100 may be readily moved vertically with respect to the piston, which is defined as movement in the direction of the arrow U, away from a vertical surface 300 such as a countertop on which the piston may be resting.

FIG. 8 shows the engagement position, in which the sleeve has been rotated with respect to the piston such that the interior end of each of the bumpers are touching the corresponding engagement surfaces. In FIG. 8, one of the bumpers 130 is shown rotationally aligned with one of the engagement surfaces 230. In this example, only include one bumper and one engagement surface may be provided; alternatively, a preferred measuring cup may include a plurality of bumpers and engagement surfaces but the other bumpers are positioned at the back side of the sleeve and not visible in the version shown in FIG. 8. In a version having three bumpers and three engagement surfaces, the positioning of the three bumpers can be seen in FIG. 2 (although in FIG. 2 the sleeve is positioned lower with respect to the piston, and has not been moved upward as in FIG. 8). When the sleeve is in this engagement position with respect to the piston, the interior end of the bumper frictionally engages the engagement surface of the piston. Preferably, the bumper and engagement surface (or, when present in a particular embodiment, the plurality of bumpers and corresponding plurality of engagement surfaces) form an interference fit in which the interior surface of the bumper is deformed due to the interference fit. The interference fit provides a stronger frictional engagement to maintain the sleeve in the desired location.

In use, the sleeve may initially be in a storage position such as shown in FIG. 2, in which the interior surfaces of one or more bumpers is engaged with the corresponding one or more engagement surfaces. The sleeve can be rotated with respect to the piston into a disengagement position in which the bumpers are moved away from the engagement surfaces and positioned over the disengagement surfaces. Then the sleeve can be moved vertically with respect to the piston, to a height above the piston to create a desired internal volume, corresponding to a desired volumetric indicator. The sleeve can then be rotated into the engagement position with respect to the piston, in which the one or more interior surfaces of the bumpers engages the corresponding one or more engagement surfaces. Once in this position, the user can fill the interior volume with the desired cooking ingredient. The measured ingredient may be expelled by tipping the adjustable measuring cup and pouring it out, or by moving the sleeve back to the disengagement position to allow the piston to be urged upward with respect to the sleeve to expel the measured ingredient. When finished, the process may be repeated with another ingredient, and finally may be returned to the storage position.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims.

I claim:

1. An adjustable measuring cup, comprising:
a piston having an upper end terminating in a platform and an opposing lower base;
a sleeve having an upper rim, a lower end, an interior sidewall and an exterior sidewall, the piston being received within the sleeve for movement of the piston with respect to the sleeve along a central axis to create a plurality of selectable interior volumes, each of the selectable interior volumes being bounded by the platform, the upper rim, and a selected portion of the interior sidewall between the platform and the upper rim;
the piston further having an engagement surface and a disengagement surface, the engagement surface extending radially outwardly from the piston relatively farther than the disengagement surface; and
a bumper mounted on the sleeve, the bumper having an interior surface extending radially inwardly from the interior sidewall;
the sleeve being rotatable with respect to the piston about the central axis for rotational movement of the sleeve between an engagement position and a disengagement position, wherein in the engagement position the interior surface of the bumper is frictionally engaged with the engagement surface, and in the disengagement position the interior surface of the bumper is disengaged from the engagement surface and positioned over the disengagement surface.

2. The adjustable measuring cup of claim 1, wherein the engagement surface extends parallel to the central axis.

3. The adjustable measuring cup of claim 2, wherein the disengagement surface extends parallel to the central axis.

4. The adjustable measuring cup of claim 3, wherein the bumper further extends radially outward from the exterior sidewall of the sleeve.

5. The adjustable measuring cup of claim 1, further comprising a plurality of bumpers and a plurality of engagement surfaces, wherein in the engagement position the interior surface of each of the plurality of bumpers is frictionally engaged with one of the plurality of engagement surfaces, and wherein in the disengagement position the interior surface of each of the plurality of bumpers is disengaged from the plurality of engagement surfaces and is positioned over the disengagement surface.

6. The adjustable measuring cup of claim 5, wherein the plurality of bumpers comprises three or more bumpers, and wherein the plurality of engagement surfaces comprises three or more engagement surfaces.

7. The adjustable measuring cup of claim 6, wherein the disengagement surface comprises a plurality of disengagement surfaces, and further wherein each of the plurality of engagement surfaces is separated from another of the plurality of engagement surfaces by one of the plurality of disengagement surfaces.

8. The adjustable measuring cup of claim 7, wherein interior surface of each of the bumpers is formed from an elastomeric material.

9. The adjustable measuring cup of claim 7, wherein the interior surface of each of the bumpers comprises a bumper width and each of the engagement surfaces comprises an engagement surface width orthogonal to the central axis, the engagement surface width being in the range of 0.5 to 2.0 times the bumper width along a path extending at least 50 percent of the distance between the lower base and the upper end of the piston.

10. The adjustable measuring cup of claim 7, further comprising a set of volumetric markings positioned on one or the other of the sleeve or the piston.

11. The adjustable measuring cup of claim 7, further comprising an elastomeric flange extending radially outward from the piston along the perimeter of the platform.

12. An adjustable measuring cup, comprising:
a piston having a lower base and an opposing upper end terminating in a planar platform;
a hollow cylindrical sleeve having a sidewall extending between a lower end and an upper rim, the sidewall having an interior sidewall side and an exterior sidewall side;
the piston being received within the sleeve for movement of the piston with respect to the sleeve along a central axis to create a plurality of selectable interior volumes, each of the selectable interior volumes being bounded by the platform, the upper rim, and a selected portion of the sidewall between the platform and the upper rim;
the piston further having a plurality of engagement surfaces and a plurality of disengagement surfaces, each of the engagement surfaces extending along an outer portion of the piston along a path parallel to the central axis, each of the disengagement surfaces extending along the outer portion of the piston, the engagement surfaces each extending radially outwardly from the piston relatively farther than the disengagement surfaces, each of the plurality of engagement surfaces being separated from others of the plurality of engagement surfaces by one of the plurality of disengagement surfaces; and
a plurality of bumpers mounted on the sleeve, each of the plurality of bumpers having an interior surface extending radially inwardly from the interior sidewall side;
the sleeve being rotatable with respect to the piston about the central axis for rotational movement of the sleeve between an engagement position and a disengagement position, wherein in the engagement position the interior surface of each of the plurality of bumpers is frictionally engaged with one of the plurality of engagement surfaces, and in the disengagement position the interior surface of each of the plurality of bumpers is disengaged from the engagement surfaces and is positioned over one of the plurality of disengagement surfaces.

13. The adjustable measuring cup of claim 12, wherein the engagement surfaces are each distributed equidistantly about the perimeter of the piston.

14. The adjustable measuring cup of claim 13, wherein the bumpers are each distributed equidistantly about the perimeter of the sleeve.

15. The adjustable measuring cup of claim 14, wherein each of the engagement surfaces extend about the perimeter of the piston for a distance greater than that of each of the disengagement surfaces.

16. The adjustable measuring cup of claim 14, wherein the plurality of bumpers comprises three or more bumpers, and wherein the plurality of engagement surfaces comprises three or more engagement surfaces.

17. The adjustable measuring cup of claim 14, wherein interior surface of each of the bumpers is formed from an elastomeric material.

18. The adjustable measuring cup of claim 17, wherein the elastomeric material comprises silicone.

19. The adjustable measuring cup of claim 14, further comprising a set of volumetric markings positioned on one or the other of the sleeve or the piston.

20. The adjustable measuring cup of claim 14, further comprising an elastomeric flange extending radially outward from the piston along the perimeter of the platform.
